(19) United States
(12) Patent Application Publication
(10) Pub. No.: US 2003/0076957 A1
(43) Pub. Date: Apr. 24, 2003

(54) Method, system and computer program product for integrity-protected storage in a personal communication device

(76) Inventors: Nadarajah Asokan, Espoo (FI); Jan-Erik Ekberg, Helsinki (FI); Lauri Paatero, Helsinki (FI)

Correspondence Address: MORGAN & FINNEGAN, L.L.P., 345 Park Avenue, New York, NY, 10154, US

(21) Appl. No.: 09/978,701

(22) Filed: Oct. 18, 2001

(51) Int. Cl. G06F 12/14

(52) U.S. Cl. 380/270; 713/167

(57) ABSTRACT

Method, system and computer program product for achieving integrity-protected storage in a personal communication device by implementing DRM in a personal communication device. In particular, the method, system and computer program product utilizes cryptography and an external, read-write storage device that stores important state information that need not be secret, but should be unmodifable or replayable without detection. Using the present invention, the integrity of data storage in a personal communication can be assured even if data is stored in an insecure storage device.

### FIELD OF THE INVENTION

A method, system and computer program product for achieving integrity-protected storage in a personal communication device by implementing a digital rights management (DRM) scheme on a personal communication device. In particular, the method, system and computer program product combines cryptography and with an external tamper-resistant storage to securely protect critical data from unauthorized use or modification.

### BACKGROUND OF THE INVENTION

Digital Rights Management (DRM) is a technology providing mechanisms for controlling consumption of digital content. DRM is already being used to some extent in the wireline Internet domain, but there is currently no widespread DRM system that is used in the mobile domain, such as for personal digital assistants (PDAs) or mobile telephones.

One of the attractive features of DRM is superdistribution, that is, the ability of a data content owner to forward data content to a user and be able to get paid each time the data is used. However, in order to accomplish this, security-critical applications in a personal communication device must be able to store “state” information related to the data sent. For example, a user of a personal communication device might buy the right to play a song 10 times on a personal communication device from the owner of the data. The rights are delivered as an electronic voucher that specifies a 10-use restriction, presumably by a counter. However, if the user can reset the counter after each use, the song can be played indefinitely without having to pay the owner of the data for each use.

Cryptography is one practical technology that can be used to control the consumption of such critical data. Cryptography involves the encoding or encrypting of digital data to render them incomprehensible by all but the intended recipients. In other words, the data is encrypted and the decryption key is delivered to those terminals or users that have paid to consume the data content. To this end, cryptographic systems can be used to preserve the privacy and integrity of the data by preventing the use and alteration of data by unauthorized parties.

For example, a plaintext message consisting of digitized sounds, letters and/or numbers can be encoded numerically and then encrypted using a complex mathematical algorithm that transforms the encoded message based on a given set of numbers or digits, also known as a cipher key. The cipher key is a sequence of data bits that may either be randomly chosen or have special mathematical properties, depending on the algorithm or cryptosystem used. Sophisticated cryptographic algorithms implemented on computers can transform and manipulate numbers that are hundreds or thousands of bits in length and can resist any known method of unauthorized decryption. There are two basic classes of cryptographic algorithms: symmetric key algorithms and asymmetric key algorithms.

Symmetric key algorithms use an identical cipher key for both encrypting by the sender of the communication and decrypting by the receiver of the communication. Symmetric key cryptosystems are built on the mutual trust of the two parties sharing the cipher key to use the cryptosystem to protect against distrusted third parties. A well-known symmetric key algorithm is the National Data Encryption Standard (DES) algorithm first published by the National Institute of Standards and Technology. See Federal Register, Mar. 17, 1975, Vol. 40, No. 52 and Aug. 1, 1975, Vol. 40, No. 149. The sending cryptographic device uses the DES algorithm to encrypt the message when loaded with the cipher key (a DES cipher key is 56 bits long) for that session of communication (the session key). The recipient cryptographic device uses an inverse of the DES algorithm to decrypt the encrypted message when loaded with the same cipher key as was used for encryption.

Asymmetric key algorithms use different cipher keys for encrypting and decrypting. In a cryptosystem using an asymmetric key algorithm, the user makes the encryption key public and keeps the decryption key private, and it is not feasible to derive the private decryption key from the public encryption key. Thus, anyone who knows the public key of a particular user could encrypt a message to that user, whereas only the user who is the owner of the private key corresponding to that public key could decrypt the message. This public/private key system was first proposed in Diffie and Hellman, “New Directions in Cryptography,” IEEE Transactions on Information Theory, November 1976, and in U.S. Pat. No. 4,200,770 (Hellman et al.), both of which are hereby incorporated by reference.

Crytographic systems, as noted above, can be used in smaller personal communication devices. In such devices, it has been possible to store “state” information in an insecure external storage in a couple of ways. First, by writing a snapshot to the state information and computing its “checksum,” e.g., by using a one-way hash function. The result is stored within a tamper-resistant memory location of the device. Therefore, if someone changes the contents of the external storage, the checksum of the result will not match the checksum value stored within the personal device. Second, using a monotonic, persistent counter within the device. Every time there is a state change, the state information is stored along with the current counter value encrypted using a device key. Thus, no one can change the encrypted state information without the key.

However, both of these prior art methods require a small amount of read-write, tamper-resistant storage within the device itself. This might not always be feasible because of the expense of read-write storage.

Therefore, it is desirable to provide a system, method and computer program product that provides improved integrity-protected storage for a personal communication device using a read-write, external tamper-resistant storage device. The system, method and computer program product of the present invention disclosed herein address this need.

### SUMMARY OF THE INVENTION

A method, system and computer program product for achieving integrity-protected data storage of critical data in a personal communication device using cryptography.

The method, system and computer program product of the present invention uses an external, tamper-resistant storage device that stores important state information that cannot be modified without detection. Using the present invention, the integrity of data storage in a personal communication can be assured even if data is stored in an insecure storage device.

It is contemplated by the invention that the integrity-protected communication is achieved using at least three basic protocols: 1) create, 2) read and 3) write between the external read-write storage device and the secure module of the personal communication device.

The invention also contemplates that the tamper-resistant, read-only storage device stores various secret keys.

The invention also contemplates that the external, tamper-resistant storage is a read-write storage device that stores an encryption key pair and a compliance certificate issued by the manufacturer of the device.

It is also contemplated by the invention that an additional insecure storage device can be used in which secret data can be stored by encrypting it with a stored secret key.

### BRIEF DESCRIPTION OF THE DRAWINGS

The accompanying figures best illustrate the details of the method, system and computer program product of the present invention for achieving integrity-protected communication for a personal communication device. Like reference numbers and designations in these figures refer to like elements.

FIG. 1 is a network diagram depicting a personal communication device including two storage devices in accordance with an embodiment of the invention.

FIG. 2 is a network diagram depicting a personal communication device including three storage devices in accordance with an embodiment of the invention.

FIG. 3 is a more detailed diagram of the two tamper-resistant storage devices of the personal communication device in accordance with an embodiment of the invention.

FIG. 4 is a flow diagram depicting the execution of the create protocol in accordance with an embodiment of the invention.

FIG. 5 is a flow diagram depicting the execution of the read protocol in accordance with an embodiment of the invention.

FIG. 6 is a flow diagram depicting the execution of the update protocol in accordance with an embodiment of the invention.

FIG. 7 is a flow diagram depicting the execution of the delete protocol in accordance with an embodiment of the invention.

FIG. 8 is a more detailed diagram of the two tamper-resistant storage devices an d the one insecure storage device of the personal communication device in accordance with an embodiment of the invention.

### DETAILED DESCRIPTION OF THE INVENTION

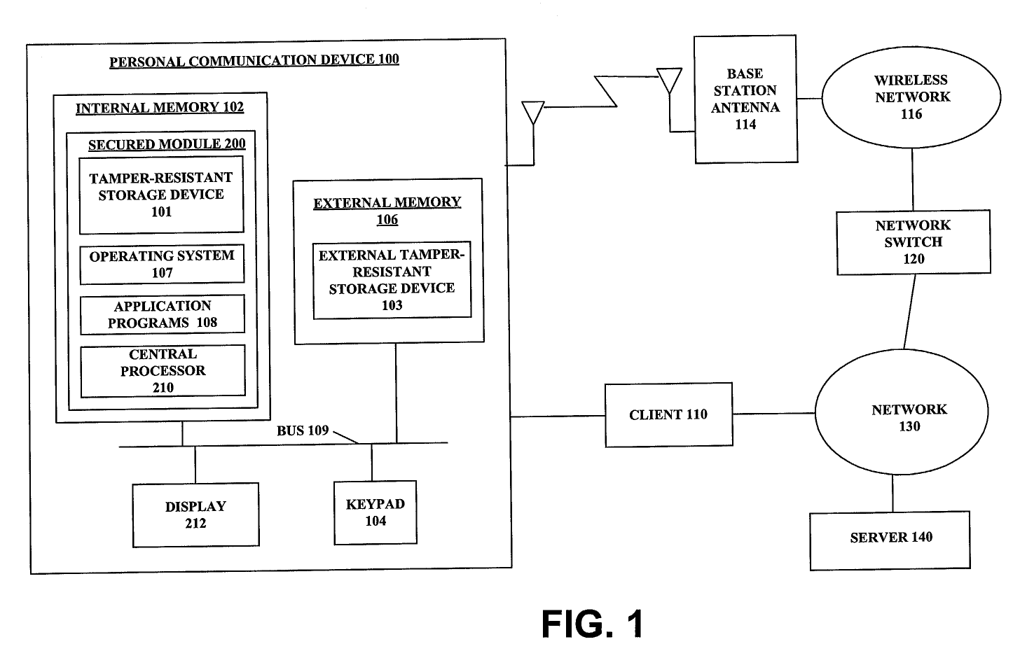

FIG. 1 illustrates an embodiment of the integrity-protected storage system of the present invention incorporated into a wireless, personal communication device 100 such as a wireless telephone, a satellite telephone, a personal digital assistant, or a bluetooth device. The personal communication device 100 includes an internal memory 102 and an external memory 106. Within the internal memory there is a secured module 200 that provides tamper-resistant storage for several elements and systems of the personal communication device 100. For example, the secured module 200 provides secured storage for a tamper-resistant storage device 101, central processor 210, operating system 107 and application programs 108. It is assumed in this embodiment of the invention that the personal communication device 100 does not have any read-write storage internal to the device that is tamper-resistant or otherwise. Tamper-resistant is a term known in the art that defines a secure section or memory or storage. A tamper-resistant boundary makes it difficult for an attacker to get at an internal element or data within a secure section. The tamper-resistant storage 101 is a read-only memory that is in communication with an external tamper-resistant storage device 103 of the external memory 106 via the bus 109. The external, tamper-resistant storage device 103 is a read-write memory device. The external storage device 103 is an electronic card such as smartcard, flashcard or WIM card that is received by the personal communication device 100.

Communication between the internal memory 102 and the external memory 106 is achieved using various protocol executed by the operating system 107 and the central processor 210. The application programs 108 are executed by the central processor 210 and comprise operating features that are performed by the personal communication device 100 such as an electronic purse application or other DRM applications. The protocol used for communication between the tamper-resistant storage device 101 and the external tamper-resistant storage device 103 include a create protocol, a read protocol and a write protocol. A user (not shown) can communicate with the personal communication device 100 via the keypad 104 and the display 212. The personal communication device 100 in FIG. 1, is a wireless communication device that is connectable to a wireless network to received and transmit data. The personal communication device in FIG. 1 is connectable to a wireless network 116 via a transmitted signal such as a frequency-modulated signal from the device 100 and received by a base station antenna 114. From the wireless network, the personal communication device can be connected to a computer server 140 via a network 130 and a wireless network switch 120. The network 130 can be a server, Intranet, Internet, public switching network (PSTN), public exchange (PBX) or the like. The client 110 is a server or personal computer that is connectable to the public network 130 via a modem and is used to initialize the personal communication device 100 as well as add and delete application programs 108.

The typical size requirements for the tamper-resistant storage device 101 is 128-256 bits of read-only memory. The tamper-resistant storage 101 can store device keys that can be used to convert data stored in insecure storage into secret storage. The typical size requirement of the external tamper-resistant storage device 103 is 128-256 bits of read-write memory. This storage 103 can be used to store important “state” information that need not be secret, but should be unmodifable or replayable without detection of such things as the number of uses of data content, number of copies made, copies that were moved or given to some other device.

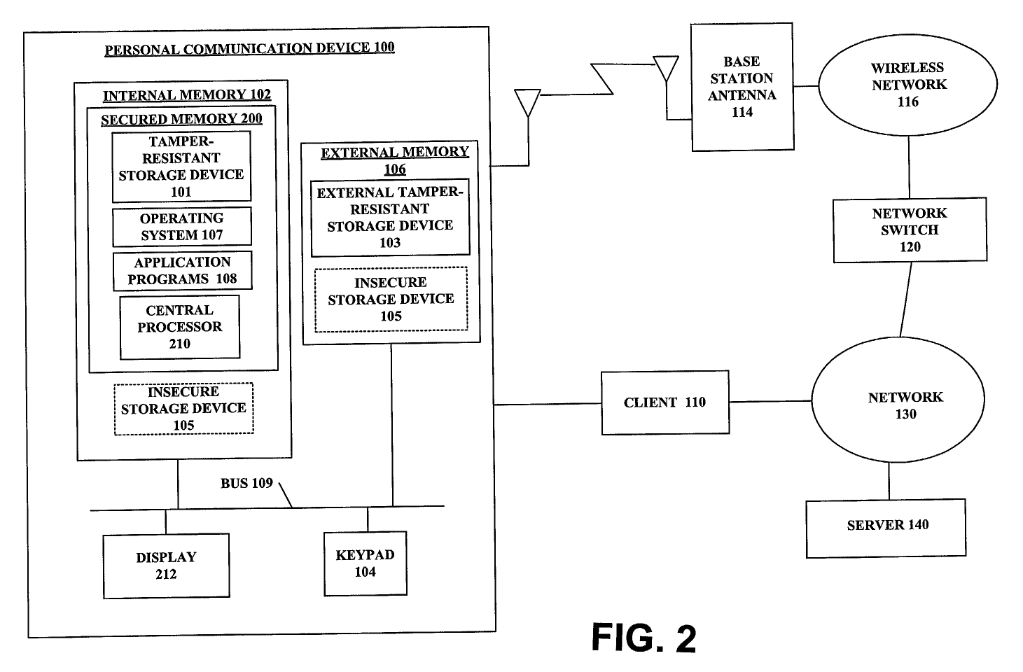

FIG. 2 is directed to another embodiment of the invention that illustrates a personal communication device 100 with an additional insecure storage device 105 that can be used as an internal or external storage device. Insecure as described herein means that the storage device is not tamper-resistant, as previously described. If the insecure storage device 105 is used as an internal storage device, it will be hardwired within the internal memory 102 of the personal communication device. If the insecure storage device 105 is used as an external storage device, it will be a removable electronic card such as a smartcard, flashcard, or WIM card. For example, the personal communication device 100 of FIG. 2 includes an internal memory 102 comprising a tamper-resistant storage device 101, an operating system 107, application programs 108 and an insecure storage device 105. The tamper-resistant storage device 101 and insecure storage device 105 are in communication with each other and each with an external tamper-resistant storage device 103 using a protocol executed by the operating system 107 and central processor and via the bus 109. The tamper-resistant storage device 101, the insecure storage device 105 and the external tamper resistant storage device 103 of FIG. 2 have the same minimal storage requirements as discussed previously for the tamper-resistant storage device 101 and external tamper-resistant storage device 103 in FIG. 1. In another arrangement, the external memory 106 comprises an external tamper-resistant storage device 103 and the insecure storage device 105. In this arrangement, the external storage device 103 and the insecure storage device 105 are also in communication with the components 101, 107, 108 of the memory 102 via the bus 109 using a protocol executed by the operating system 107 and the central processor 210.

The insecure storage device 105 can be used to store secure data (i.e., “state information”) by encrypting the data with a secret key. However, because the insecure storage device 105 is not tamper-resistant, it cannot provide the same level of integrity-protection as the tamper-resistant storage devices 101, 103. For example, in this embodiment, the “state” information stored in the insecure storage device 105 is encrypted with a secret key 101a from the tamper-resistant storage device 101. A corresponding integrity-protection check value such as a checksum or a counter, as described in the prior art, is stored in the external, tamper-resistant storage device 103. Communication between the tamper-resistant storage device 101, the external tamper-resistant storage device 103 and the insecure storage device 105 is achieved using a protocol executed the operating system 107 and a central processor 210 of the device 100. The protocols comprise at a create, read and update protocol. Again, the client 110 is a server or personal computer that is used to initialize the personal communication device 100 and is connectable to the public network 130 using a connection such as a modem connection.

As mentioned previously, a user (not shown) can communicate with the personal communication device 100 using a keypad 104 and display 212. The personal communication device in FIG. 2 (as in FIG. 1) is connectable to a wireless network 116 via a transmitted signal such as a frequency-modulated signal received from a base station antenna 114. From the wireless network the personal communication device 100 can be connected to a computer server 140 from a network 130 and a wireless network switch 120. The network 130 can comprise a server, the Internet, an Intranet, a PSTN, a PBX, or the like.

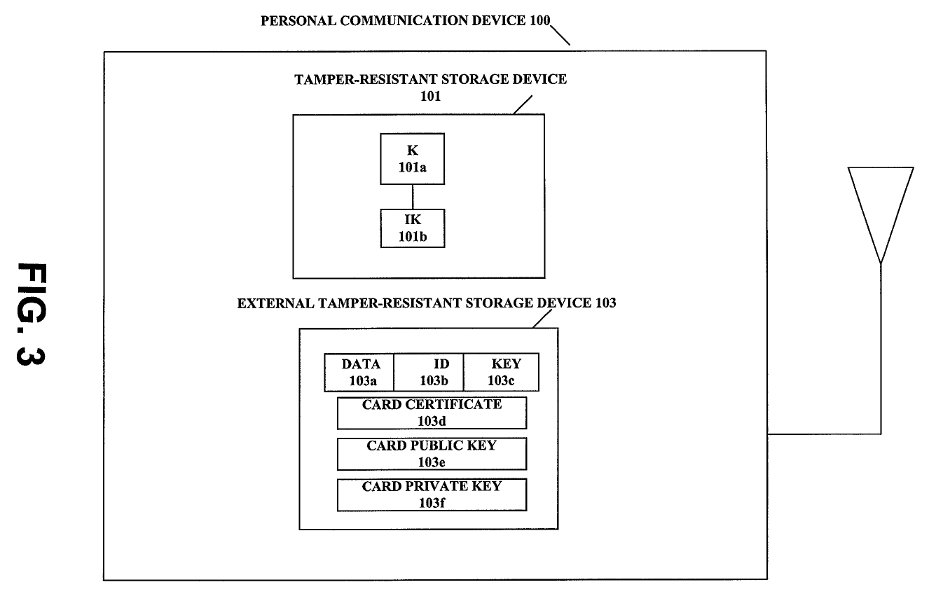

FIG. 3 illustrates in more detail the tamper-resistant storage device 101, and the external tamper-resistant storage device 103 of the personal communication device 100 in accordance with an embodiment of the invention. The tamper-resistant storage device 101 has a secret key 101a from which an integrity key 101b can be derived. However, the integrity key 101b can also be determined independently from the secret key 101a as well. The personal communication device does not have any read-write storage, tamper-resistant or otherwise. In other words, the personal communication device 100 does not have any hardwired read-write memory. Thus, the only read-write storage would be provided by the external tamper-resistant storage device 103. The external tamper-resistant storage device 103 is an electronic card such as a smartcard, flashcard or WIM card having read-write storage. The external tamper-resistant storage device 103 has an encryption key pair that consists of a device public key 103e and a device private key 103f. Additionally, the external tamper-resistant storage device 103 includes a device certificate 103d or compliance certificate that is used to prove that the external tamper-resistant storage device 103 was manufactured by a trusted third party. The external tamper-resistant storage device 103 has a memory location for storing data 103a, a device identification 103b and a secret key 103c. In this embodiment, the device identification 103b and key 103c are the device identity and integrity key 101b supplied by the tamper-resistant storage device 101. The integrity key is used for authenticating a request to read, write or update the data 103a stored in the external tamper-resistant storage device 103. Additionally, the card certificate 103d stored in the external tamper-resistant storage device 103 is used by the storage tamper-resistant storage device 101 to assure that the external tamper-resistant storage device 103 is manufactured by a trusted third party.

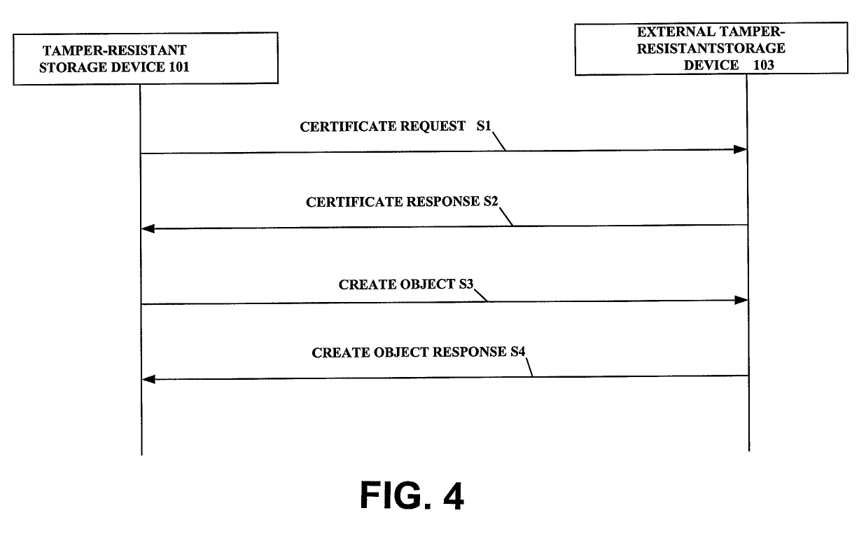

FIG. 4-6 illustrates the steps for achieving integrity-protected storage in the personal communication device 100 through communication between the external tamper-resistant storage device 103 and the tamper-resistant storage device 101 illustrated in FIG. 3.

FIG. 4 illustrates the steps involved for executing the create protocol that is used for creating an object for achieving integrity-protected storage in personal communication device 100. Initially, in step S1 tamper-resistant storage device 101 requests the card certificate 103a stored in the external tamper-resistant storage device 103. In step S2 the tamper-resistant storage device 101 receives the card certificate 103d and verifies that it is a compliant card using a certificate chain. Typically, two certificates can be used in order for the tamper-resistant storage device 101 to verify that the external tamper-resistant storage device 103 possesses a compliant card certificate 103d. For example, a certificate issued by the manufacturer of the tamper-resistant storage device 101 to the manufacturer of the external tamper-resistant storage device 103, and a compliant card certificate issued by the manufacturer of the external tamper-resistant storage device 103 to the external tamper-resistant storage device 103 itself. Once the card certificate is verified, an object is created in step S3. To this end, in S3, the tamper-resistant storage device 101 sends the integrity key 101b encrypted with the public key 103e of the external tamper-resistant storage device 103. Additionally, the tamper-resistant storage device also sends, in step S3, an identifier ID that uniquely identifies the object to be created, which also includes an identifier that is unique to the tamper-resistant storage device 101. The unique identifier is also encrypted with the public key 103e of the external tamper-resistant storage device 103. It is important to note that the key pair 103e, 103f stored in the external tamper-resistant storage device 103 is used only for the purpose of this protocol. In step S4, the external tamper-resistant storage device 103 stores the unique identifier and integrity key along with the data to be protected, as indicated in FIG. 3 by 103a, 103b and 103c. The external tamper-resistant storage device 103 will use the integrity key 103c in any subsequent read and write requests from the tamper-resistant storage device 101.

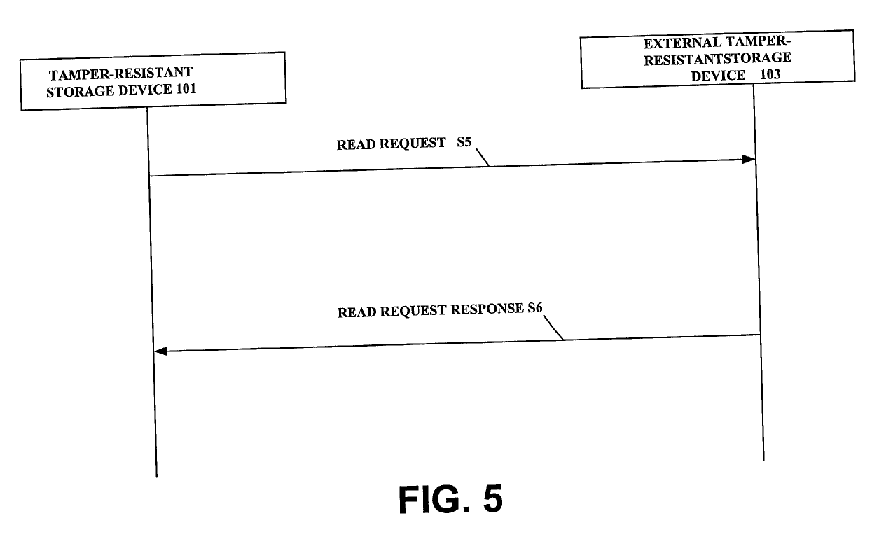

FIGS. 5 & 6 illustrate the read and write protocol used for communication between the tamper-resistant storage device 101 and the external tamper-resistant storage device 103 in accordance with an embodiment of the invention. FIG. 5 illustrates the steps for the tamper-resistant storage device 101 reading data from the external tamper-resistant storage device 103. In step S5, the tamper-resistant storage device 101 issues a challenge to the external tamper-resistant storage device 103. In step S6, the external tamper-resistant storage device 103 responds to the challenge by the tamper-resistant storage device 101 by sending the data along with a message authentication code on the data to the tamper-resistant storage device 101. The message authentication code is completed using a message authentication code function such as HMAC-MD5 with an integrity key 103c as the key of the MAC function, and the object created in FIG. 4 as the input of the MAC function. Note that the original read request from the tamper-resistant storage device 101 can also be authenticated using a message authentication code if necessary. Moreover, the external tamper-resistant storage device 103 can also use a digital signature to authenticate the response to the read request by the tamper-resistant storage device 101.

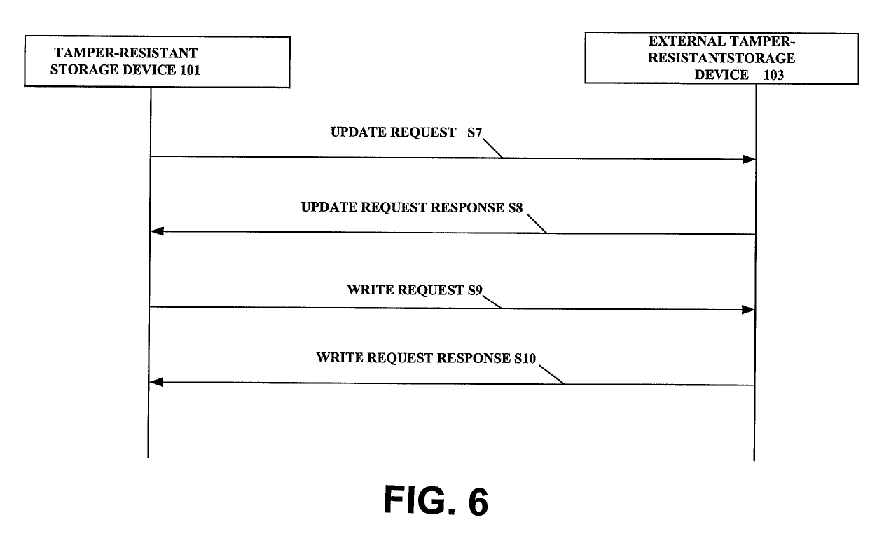

FIG. 6 illustrates the write or update request protocol between the tamper-resistant storage device 101 and the external tamper-resistant storage device 103 in accordance with an embodiment of the invention. In step S7, the tamper-resistant storage device 101 requests that the external tamper-resistant storage device 103 issues a challenge to the tamper-resistant storage device 101. In step S8, the external tamper-resistant storage device 103 responds by sending a challenge to the tamper-resistant storage device 101. In step S9, the tamper-resistant storage device 101 then sends a write request to the external tamper-resistant storage device 103 along with an authentication code and its own challenge. The authentication code is constructed using the integrity key 101b and device identifier specific to the object to be created. In step S9, the external-tamper-resistant storage device 103 authenticates the write request sent by the tamper-resistant storage device 101 using the integrity key 103c previously stored in the external tamper-resistant storage device during the creation protocol illustrated in FIG. 4. The external tamper-resistant storage device 103 also sends a response to the tamper-resistant storage device 101 indicating that the write request is allowed or disallowed.

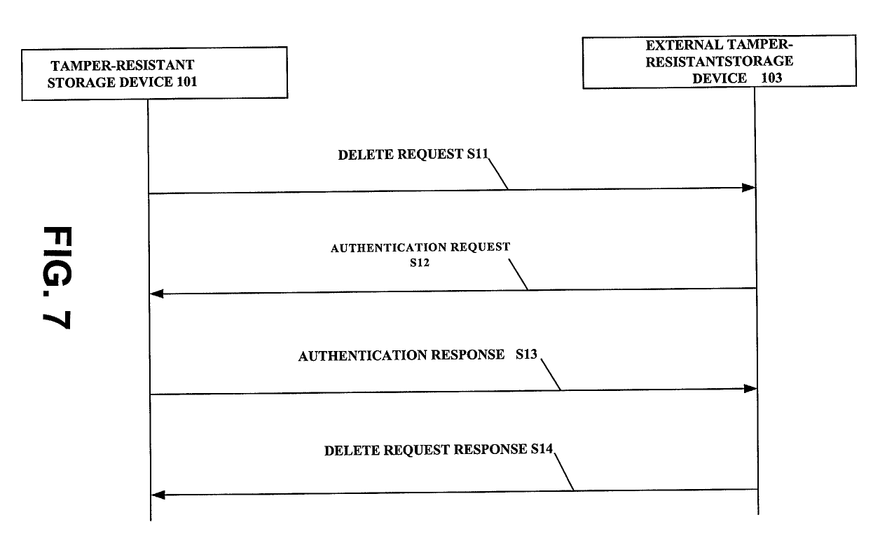

FIG. 7 is directed to another embodiment of the present invention. Specifically, FIG. 7 illustrates the use of a delete protocol. In step S11, the tamper-resistant storage device 101 issues a delete request to the external tamper-resistant storage device. In step S12, the external tamper-resistant storage device authenticates the request by issuing a challenge to the internal tamper-resistant storage device 101. In S13, the external tamper-resistant storage device responds to the authentication request by sending the ID of the object to be deleted, and the MAC computed using the corresponding integrity key 103c. The external tamper-resistant storage device 103 will perform the deletion and acknowledge the delete request in step S14. The response to the deletion request in step S14 can also be authenticated using a MAC for a higher level of security.

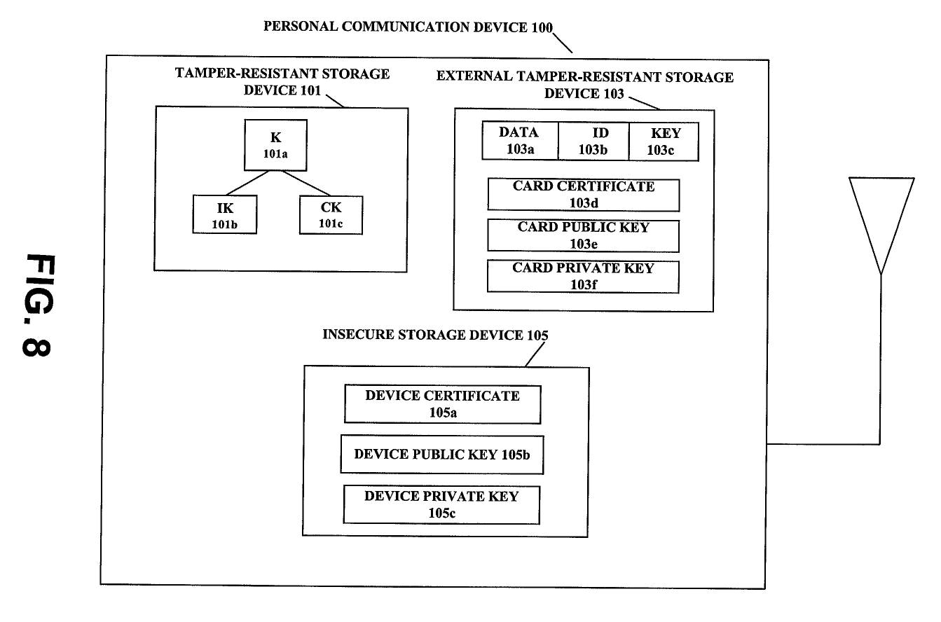

FIG. 8 illustrates a more detailed diagram of the personal communication device 100 as illustrated in FIG. 2 and in accordance with another embodiment of the present invention. In FIG. 8, the personal communication device 100 includes a tamper-resistant storage device 101, an external tamper-resistant storage device 103 and an insecure storage device 105. The tamper-resistant storage device 101 includes an integrity key 101b and a confidentiality key 101c. Both the integrity key 101b and the confidentiality key 101c can be determined independently or computed deterministically from a common underlying device key 101a. As indicated in the previous embodiment, the integrity key 101b and the confidentiality key 101c are stored in the read-only, tamper-resistant storage device 101. The external tamper-resistant storage device 103 is comprised of the same elements as described and indicated in FIG. 3. In other words, the external tamper-resistant storage device 103 is an electronic card such as a smartcard, flashcard or WIM card having read-write storage. The external tamper-resistant storage device 103 has an encryption key pair that consists of a device public key 103e and a device private key 103f. Additionally, the external tamper-resistant storage device includes a device certificate 103a or compliance certificate that is evidence that the external tamper-resistant storage device 103 was manufactured by a trusted third party. The external tamper-resistant storage device 103 also has a memory location for storing protected data 103a, device identification 103b and a secret key 103c. In this embodiment, the device identification 103b and key 103c are the ID and integrity key 102a supplied by the tamper-resistant storage device 101. The device ID and the key 102a are used to authenticate read and update requests of data stored in the external tamper-resistant storage device 103. Additionally, the card certificate 103d stored in the external tamper-resistant storage device 103 is used by the storage tamper-resistant storage device 101 to assure that the external tamper-resistant storage device 103 is manufactured by a trusted third party.

The personal communication device in FIG. 8 also includes an insecure storage device 105. The insecure storage device can be external (i.e., an electronic card) or internal (i.e., hardwired) to the personal communication device 100. The insecure storage device stores a device certificate 105a, and a device key pair 105b, 105c. In this embodiment of the present invention, the insecure storage device 105 is used to stored “state” data that is encrypted with the confidentiality key 101c of the tamper-resistant storage device 101. A corresponding integrity-protected checksum or counter, as described in the prior art, is stored in the external tamper-resistant storage device 103. Communication between the insecure storage device 105, the external tamper-resistant storage device 103 and the tamper-resistant storage device 101 is achieved using the same protocol as previously described in FIGS. 4-6. This embodiment also allows different applications in the tamper-resistant storage device 101 to have different integrity keys. For example, an electronic purse application stored in the tamper-resistant storage device 101 may use key IK1 and a DRM application on the same device may use an integrity key IK2. The operating system of the tamper-resistant storage device will provide integrity-protected storage for IK1 and IK2 by encrypting them with the confidentiality key 101c and storing them in a storage location of the insecure storage device 105. This is possible because the external tamper-resistant storage device 103 does not attempt to authenticate the creator of the objects in any way. However, once an object is created and is associated with a key, all future requests to read or update the data will be authenticated by that key. This makes it possible to let different applications stored in the same device to used different keys. The only strict requirement is that the keys be stored in a tamper-resistant manner.

As another alternative for this embodiment, the basic scheme of the system can be used on existing smartcard presently used by a personal communication device. This is because some existing smartcards support a tamper-resistant counter. Using the present invention, the counter value could be stored in the insecure storage device 105 encrypted with a confidentiality key 101c. However, this would entail the following modifications. The object creation will write the object to the insecure storage device 105, and initialize the counter in the external tamper-resistant storage device 103. The object update will update the object on the insecure storage device 105, and increment the counter on the external tamper-resistant storage device 103. This embodiment can be implemented on smartcards that have signature capability and protect files using PINS by using the PIN code instead of a key and a MAC.

Although illustrative embodiments have been described herein in detail, its should be noted and understood that the descriptions and drawings have been provided for purposes of illustration only and that other variations both in form and detail can be added thereupon without departing from the spirit and scope of the invention. The terms and expressions have been used as terms of description and not terms of limitation. There is no limitation to use the terms or expressions to exclude any equivalents of features shown and described or portions thereof.

We claim:

1. A system for integrity-protected storage in a personal communication device, comprising:
a first storage device;
a second storage device and
a processor disposed in communication with said first and said second storage device configured to:
authenticate said second storage device;
create a secure object to be stored in said second storage device using at least one secret key from said first storage device; and
granting access to data stored in said second storage device using said secret key.

2. The system of claim 1, wherein said first storage device is a read-only memory device.

3. The system of claim 1, wherein said second storage device is an external, read-write memory device.

4. The system of claim 1, wherein said first and said second storage devices are tamper-resistant memory devices.

5. The system of claim 3, wherein said second storage device is a removable electronic card that is received by said personal communication device.

6. The system of claim 1, wherein said first storage device further comprise an integrity key and confidentiality key.

7. The system of claim 1, wherein the communication between said processor and said first and second storage devices comprises the execution of a plurality of protocols using an operating system of the personal communication device.

8. The system of claim 7, wherein said plurality of protocols are comprised of a create protocol, a read protocol and an update protocol.

9. The system of claim 7, wherein said plurality of protocols further comprises a delete protocol.

10. The system of claim 1, further comprising an insecure storage device for storing data encrypted with said secret key.

11. The system of claim 10, wherein said insecure storage device is an external, read-write storage device.

12. The system of claim 1, wherein said personal communication device comprises a cellular telephone, a satellite telephone, a personal digital assistant or a bluetooth device.

13. A system for integrity-protected storage of data in a personal communication device, comprising:
a tamper-resistant storage device that stores at least one secret key;
an external tamper-resistant storage device that stores an encryption key pair and a compliance certificate; and
a processor for executing a plurality of protocols for communication between said tamper-resistant storage device and said external tamper-resistant storage device;
wherein upon initiation of a communication protocol said tamper-resistant storage device requests the compliance certificate from said external tamper-resistant storage device and said tamper-resistant storage device sends the integrity-protected key along with a unique identifier to said external tamper-resistant storage device, which is used by said external tamper-resistant storage device to authenticate a subsequent request to read and update data stored in said external tamper-resistant storage device.

14. The system of claim 13, wherein said tamper-resistant storage device is read-only storage.

15. The system of claim 13, wherein said external tamper-resistant storage device is a read-write storage device.

16. The system of claim 13, wherein said external tamper-resistant storage device is a removable electronic card received by said personal communication device.

17. The system of claim 13, wherein said tamper-resistant storage device further comprises an integrity key and a confidentiality key.

18. The system of claim 13, where a plurality of protocols executed by said processor comprises a create protocol, a read protocol and a write protocol

19. The system of claim 13, further comprising an insecure storage device storing data encrypted with said secret key.

20. The system of claim 18, wherein said plurality of protocols further comprises a delete protocol.

21. The system of claim 19, where in said insecure storage is an external, read-write storage device.

22. The system of claim 13, wherein said personal communication device comprises a cellular telephone, a satellite telephone, a personal digital assistant or a bluetooth device.

23. The method for storing data in a personal communication device, comprising:
authenticating a second storage device;
creating a secure object following the authentication of said second storage device using a secret key of a first storage device;
storing said secure object in said second storage device; and
granting access to data stored in said second storage device using said secret key.

24. The method of claim 23, wherein said first storage device is a read-only memory device.

25. The method of claim 23, wherein said second storage device is a read-write memory device.

26. The method of claim 23, wherein the authenticating of said second storage device further comprises:
receiving a compliance certificate and a public key from the second storage device; and
verifying the authenticity of the compliance certificate.

27. The method of claim 23, wherein the receiving of the compliance certificate and the public key is in response to a request from said first storage device.

28. The method of claim 23, wherein said creation of the secured object further comprises:
sending an integrity key and an identifier for the object to the second storage device; and
receiving a success indication from said second storage device.

29. The method of claim 23, wherein the personal communication device is a cellular telephone, a satellite telephone, a personal digital assistant or a bluetooth device.

30. The method of claim 28, wherein the integrity key functions to decode encrypted data accessible through the second memory device.

31. A method of storing data in a personal communication device, comprising:
requesting of a compliance certificate from a second storage device;
verifying the authenticity of the compliant card sent by said second storage device;
sending an integrity key and an object identifier from a first storage device to said second storage device upon authentication of said compliant card;
storing said integrity key and object identifier in said second storage device;
authenticating a read request from said first storage device using the stored integrity key in said second storage device;
authenticating an update request from the first storage device using said stored integrity key in said second storage device; and
granting access to data stored in said second memory device.

32. The method of claim 31, wherein said first storage device is a read-only storage device.

33. The apparatus of claim 31, wherein said second storage device is a read-write storage device.

34. The method of claim 31, further comprises storing a confidentiality key in said first storage device.

35. The apparatus of claim 34, further comprising storing encrypted data in an insecure storage using said confidentiality key.

36. The method of claim 31, wherein the personal communication device is a cellular telephone, a satellite telephone, a personal digital assistant or a bluetooth device.

37. The method of claim 31, wherein the integrity key functions to decode encrypted data accessible through the second memory device.

38. A computer program product for storing data in a personal communication device, comprising:
a computer readable medium;
program code in said computer readable medium for authenticating a second storage device;
program code in said computer readable medium for creating a secure object using a secret key from a first storage device following the authenticating of said second storage device;
program code in said computer-readable medium for storing the secure object in said second storage device
program code in said computer readable medium for granting access to the data in said second storage device using said secret key.

39. The computer program product of claim 38, wherein the program code for authenticating of said second storage device further comprises:
program code for receiving a compliance certificate and a public key from the second storage device; and
program code for verifying the authenticity of the compliance certificate.

40. The computer program product of claim 38, wherein the program code for object creation further comprises:
program code for sending an integrity key and an identifier for the object to said second storage device; and
program code for receiving a success indication from said second storage device.
